(19) United States
(12) Patent Application Publication
(10) Pub. No.: US 2023/0162059 A1
(43) Pub. Date: May 25, 2023

(54) INFORMATION PROCESSING SYSTEM AND INFORMATION PROCESSING METHOD

(71) Applicant: CANON KABUSHIKI KAISHA, Tokyo (JP)

(72) Inventors: Ryuta Ueda, Tokyo (JP); Ritsuya Tomita, Kanagawa (JP)

(21) Appl. No.: 18/056,386

(22) Filed: Nov. 17, 2022

(30) Foreign Application Priority Data
Nov. 19, 2021 (JP) 2021-188733

(51) Int. Cl. G06N 5/04; G06N 3/08

(52) U.S. Cl. CPC G06N 5/04; G06N 3/08

(57) ABSTRACT

An information processing system includes a first information processing apparatus including a training data acquisition unit configured to acquire training data, a first learning unit configured to perform first learning processing by inputting the learning data to a first partial model including the input layer and a part of a plurality of intermediate layers of an inference model, and a third learning unit configured to perform third learning processing on a third partial model including the output layer using an output obtained through second learning processing performed by a second information processing apparatus and the correct label, and the second information processing apparatus including a second learning unit configured to perform the second learning processing by inputting an output obtained through the first learning processing to a second partial model including an intermediate layer different from the part of the plurality of intermediate layers included in the first partial model.

### BACKGROUND

### Field of the Disclosure

The present disclosure relates to an information processing system and an information processing method that use an inference model based on a neural network.

### Description of the Related Art

It is known that an inference model based on a neural network is applied to medical data, such as a medical image acquired by a medical imaging apparatus (modality) and medical information acquired from a medical information system, and inference regarding a predetermined disease is made (examples of such an inference include detection of a disease, discrimination of benignity/malignancy, prognosis prediction, and risk prediction). The inference model is generated by execution of learning with training data. For example, Japanese Patent Application Laid-Open No. 2019-159820 discusses generation of an inference model by execution of learning processing on the inference model in a learning apparatus.

### SUMMARY

According to the technique discussed in Japanese Patent Application Laid-Open No. 2019-159820, the learning processing on the inference model is performed in the learning apparatus. Thus, in a case where the learning processing is performed by a user of the inference model instead of a provider of the inference model, the learning processing is performed with a neural network distributed to an information processing apparatus on the user side, in some cases. In such a case, it is difficult to prevent unauthorized use, such as the user duplicating the inference model and distributing the inference model to a third person, and modification of the inference model.

The present disclosure is directed to providing an information processing system capable of performing learning and making inference while guaranteeing confidentiality of an inference model based on a neural network.

According to an aspect of the present disclosure, an information processing system includes a first information processing apparatus to be managed by a provider of an inference model and a second information processing apparatus configured to communicate with the first information processing apparatus via a network, the information processing system being configured to perform learning processing on the inference model based on a neural network including an input layer, a plurality of intermediate layers, and an output layer. The first information processing apparatus includes a training data acquisition unit configured to acquire training data including learning data and a correct label, a first learning unit configured to perform first learning processing by inputting the learning data to a first partial model including the input layer and a part of the plurality of intermediate layers of the inference model, and a third learning unit configured to perform third learning processing on a third partial model including the output layer using an output obtained through second learning processing performed by the second information processing apparatus and the correct label. The second information processing apparatus includes a second learning unit configured to perform the second learning processing by inputting an output obtained through the first learning processing to a second partial model including an intermediate layer that is included in the inference model and is different from the part of the plurality of intermediate layers included in the first partial model.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an information processing system according to one or more aspects of the present disclosure.

FIG. 2 is a schematic view illustrating an inference model according to one or more aspects of the present disclosure.

FIG. 3 is a diagram illustrating a hardware configuration of a first information processing apparatus according to one or more aspects of the present disclosure.

FIG. 4 is a flowchart illustrating learning processing of the information processing system according to one or more aspects of the present disclosure.

FIG. 5 is a diagram illustrating a configuration of an information processing system according to one or more aspects of the present disclosure.

FIG. 6 is a diagram illustrating a configuration of an information processing system according to one or more aspects of the present disclosure.

FIG. 7 is a schematic view illustrating an inference model according to one or more aspects of the present disclosure.

FIG. 8 is a flowchart illustrating inference processing to be performed by the information processing system according to one or more aspects of the present disclosure.

FIG. 9 is a diagram illustrating a configuration of an information processing system according to one or more aspects of the present disclosure.

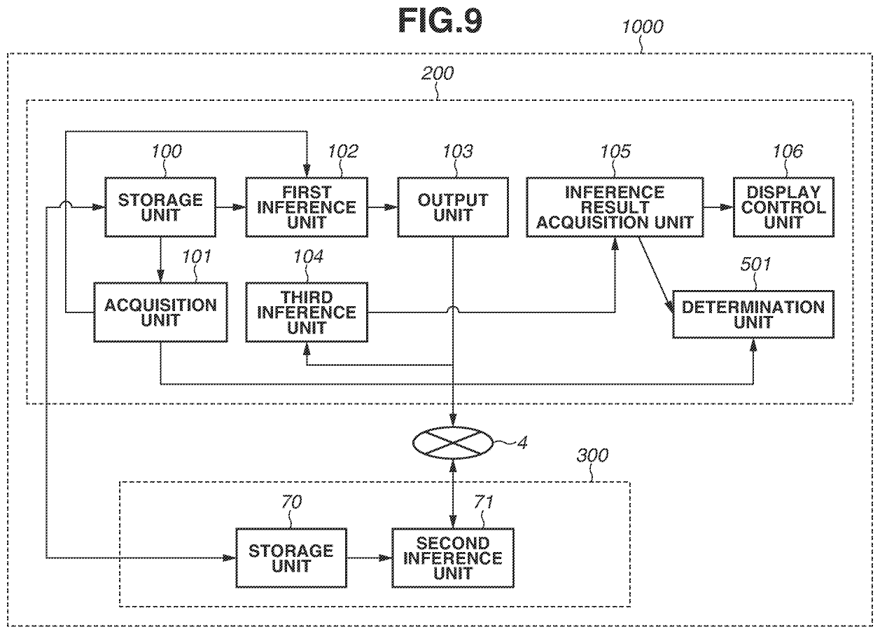

### DESCRIPTION OF THE EMBODIMENTS

The present disclosure is suitably applicable to raw data (signal data) acquired by a medical imaging apparatus (modality) and to medical data such as medical image data for diagnosis generated from the raw data through image reconstruction. Examples of the modality include an X-ray computerized tomography (CT) apparatus, a magnetic resonance imaging (MRI) apparatus, a single photon emission computed tomography (SPECT) apparatus, a positron emission tomography (PET) apparatus, and an electrocardiograph. Not only medical data, but also information regarding privacy of a patient, such as age, gender, and disease information, may serve data as data as an inference target and training data. The present disclosure is applicable not only to medical data, but also to any of publicly known data as the inference target, such as image data acquired through a security camera.

A learning step and an inference step in an information processing system according to the present disclosure will be described below. An inference model to be used in the inference step is not limited to one generated through the learning step according to the present disclosure. The inference model to be used in the inference step is a trained inference model that has been trained based on machine learning or deep learning by a publicly known method or the learning step according to the present disclosure. The trained inference model described herein is only required to be subjected to learning processing so as to satisfy a predetermined condition, and may be used as a target of additional learning, transfer learning, fine-tuning, or the like. Hence, learning processing according to the learning step (described below) may be performed as the additional learning on the trained inference model that has been trained by the publicly known method, or may be performed in a reverse order. Exemplary embodiments of the present disclosure will be described below with reference to the accompanying drawings.

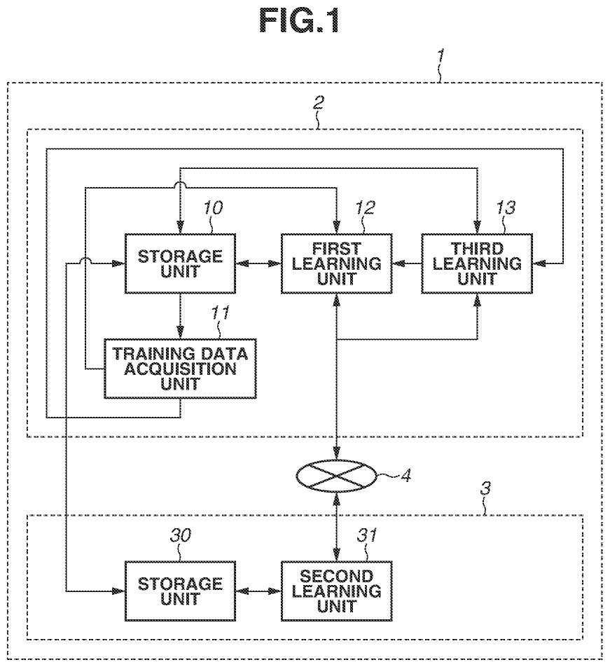

A first exemplary embodiment of the present disclosure will be described below. An information processing system 1 according to the present disclosure will now be described with reference to FIG. 1. The information processing system 1 according to the present disclosure includes a first information processing apparatus 2, a second information processing apparatus 3, and a network 4 that connects the first information processing apparatus 2 and the second information processing apparatus 3 to be communicable with each other.

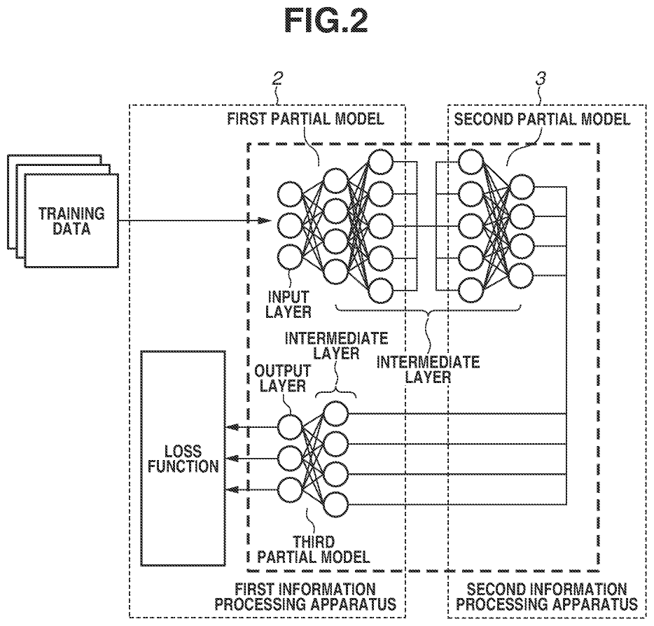

A configuration of the information processing system 1 according to the present disclosure will now be described with reference to FIG. 2. The information processing system 1 includes the first information processing apparatus 2 and the second information processing apparatus 3. The first information processing apparatus 2 and the second information processing apparatus 3 each include a partial model which is a part of the inference model to be subjected to learning processing based on training data. The inference model described herein is a trained model based on a neural network including an input layer, intermediate layers, and an output layer. A parameter for outputting an inference result is determined through the learning processing, and a model having a pair of this parameter and a network model is defined as the inference model. The inference model serving as a learning target, which is described in the present exemplary embodiment, may be a trained inference model that has been generated by execution of learning processing in another apparatus or the like and that is to be subjected to additional learning processing, or may be an inference model that has not been trained and that is to be subjected to learning processing. The training data described herein includes learning data and a correct label indicating a correct answer to the learning data. A plurality of apparatuses includes, as a partial model, the inference model that is based on one neural network (described below). In other words, the aggregation of the partial models functions as the inference model based on one neural network.

The information processing system 1 includes the first information processing apparatus 2 on the inference model provider side, the second information processing apparatus 3 on the inference model user side, and the network 4 that connects the first information processing apparatus 2 and the second information processing apparatus 3.. A network configuration of the inference model corresponding to each information processing apparatus will be described with reference to FIG. 2.

The first information processing apparatus 2 includes, of the inference model that performs inference processing on medical data and that is based on the neural network including the input layer, the intermediate layers configured with a plurality of layers, and the output layer, a first partial model including the input layer and at least a part of the plurality of intermediate layers. Furthermore, the first information processing apparatus 2 includes, of the inference model, a third partial model including at least the output layer. The first partial model and the third partial model described herein may be configured as a network for confidentiality, and a second partial model may be configured as a network for publication. With the configuration in which the first partial model and the third partial model serve as the network for confidentiality, the provider of the model can further enhance confidentiality of the inference model.

The first information processing apparatus 2 includes a storage unit 10 that stores the training data and information about the inference model. The training data includes the learning data and the correct label, and is transmitted from the user of the model or the like. The first information processing apparatus 2 includes a training data acquisition unit 11, a first learning unit 12, and a third learning unit 13. The training data acquisition unit 11 acquires the training data from the storage unit 10. The first learning unit 12 performs learning on the first partial model based on the acquired training data. The third learning unit 13 performs learning on the third partial model.

The second information processing apparatus 3 includes a storage unit 30 and a second learning unit 31. The storage unit 30 stores the information about the inference model. The second learning unit 31 performs learning on the second partial model including layers that are different from those included in the first partial model of the inference model.

The learning processing described herein represents a series of processing for forward-propagating the learning data included in the training data through a partial model and backpropagating information about an error between the correct label and an output value from the output layer (error back-propagation) to update a parameter of the partial model. The training data includes the learning data and the correct label.

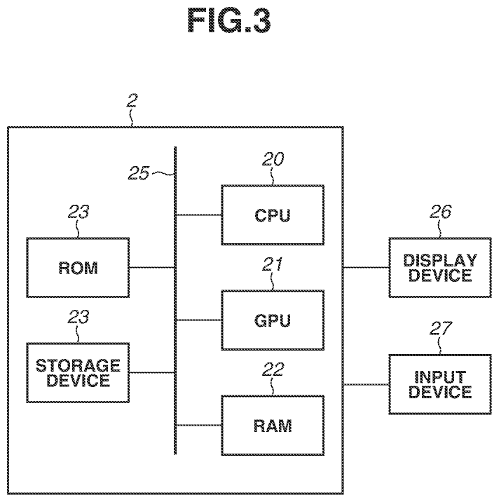

FIG. 3 illustrates a specific configuration example of the first information processing apparatus 2 or the second information processing apparatus 3. In this example, the first information processing apparatus 2 includes a central processing unit (CPU) 20, a graphics processing unit (GPU) 21, a random-access memory (RAM) 22, and a read-only memory (ROM) 23, and a storage device 24, and these devices are connected to one another through a system bus 25. A display device 26 and an input device 27, such as a mouse and a keyboard, may be connected to the first information processing apparatus 2. A configuration of the second information processing apparatus 3 is similar to the configuration of the first information processing apparatus 2, and thus is not illustrated. The second information processing apparatus 3 includes a CPU, a GPU, a RAM, a ROM, and a storage device, and these devices are connected to one another through a system bus.

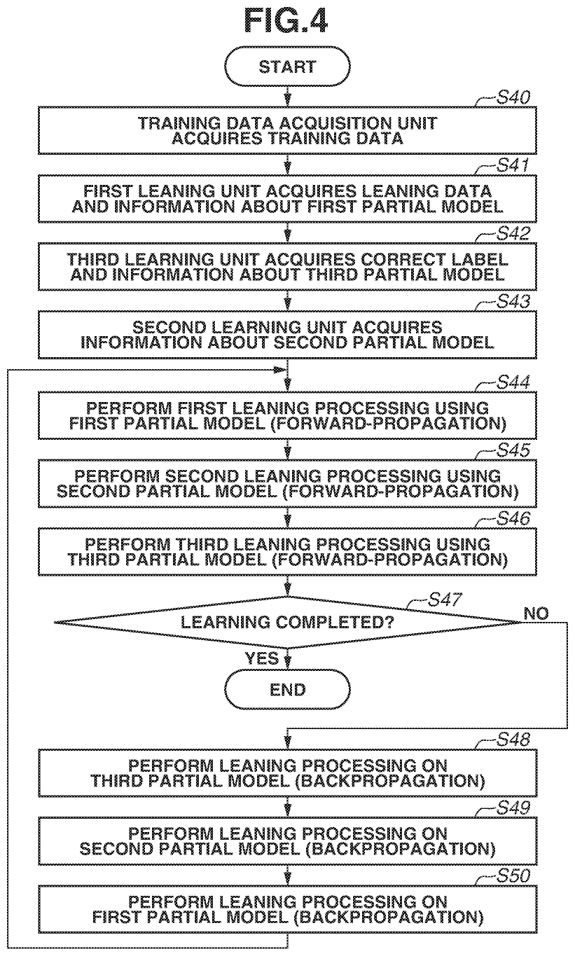

An example of the learning step of the information processing system 1 according to the present exemplary embodiment will be described below with reference to a flowchart in FIG. 4.

In step S40, the training data acquisition unit 11 acquires the training data in which the learning data and the correct label are paired from the second information processing apparatus 3. The training data acquisition unit 11 transmits information about the learning data to the first learning unit 12. The correct label is transmitted to the third learning unit 13 including the third partial model having the output layer. When the training data acquisition unit 11 completes the processing, the processing proceeds to step S41. While the information about the training data is acquired from the second information processing apparatus 3, in another exemplary embodiment, the training data may be stored in the storage unit 10, and the training data acquisition unit 11 may acquire the information about the training data by reading the training data from the storage unit 10.

In step S41, the first learning unit 12 acquires the learning data transmitted from the training data acquisition unit 11 and information about the first partial model from the storage unit 10. More specifically, the first learning unit 12 acquires the learning data from the training data in which the learning data and the correct label are paired. The information about the first partial model is, for example, the input layer and at least a part of the plurality of intermediate layers configured with the plurality of layers. Here, the first learning unit 12 may transmit the acquired information indicating the first partial model to the second information processing apparatus 3.

In step S42, the third learning unit 13 acquires information about the third partial model from the first learning unit 12 and information about the correct label from the training data acquisition unit 11. More specifically, the third learning unit 13 acquires the correct label from the training data in which the learning data and the correct label are paired. The information about the third partial model is, for example, intermediate layers configured with layers that are different from the intermediate layers included in the information about the first partial model.

In step S43, the second learning unit 31 acquires information about the second partial model from the first learning unit 12. The information about the second partial model is, for example, intermediate layers configured with layers that are different from the intermediate layers included in the information about the first partial model and those of the intermediate layer included in the information about the third partial model.

In step S44, the first learning unit 12 inputs the learning data to the first partial model and forward-propagates the learning data, thus executing first learning processing, which is a part of the learning step. In response to completion of the first learning processing, the first learning unit 12 transmits data generated through the first learning processing, for example, a tensor, to the second learning unit 31.

In step S45, the second learning unit 31 inputs a parameter transmitted from the first learning unit 12 to the second partial model and forward-propagates the parameter, thus executing second learning processing, which is a part of the learning step. In response to completion of the second learning processing, the second learning unit 31 transmits data generated by the second learning processing to the third learning unit 13.

In step S46, the third learning unit 13 inputs and a parameter transmitted from the second learning unit 31 to the third partial model and forward-propagates the parameter, thus executing third learning processing, which is part of the learning step.

In step S47, the third learning unit 13 compares an output from the third partial model as a result of the forward-propagation performed by the third partial model including the output layer in the network configuration thereof and the correct label acquired from the training data acquisition unit 11, and acquires error information using a loss function.

Here, the third learning unit 13 may determine whether learning has been completed. The third learning unit 13 determines whether the learning processing has been completed depending on whether the error information resulting from the calculation is less than a predetermined value, whether the learning processing has been executed a predetermined number of times, or the like. If the third learning unit 13 determines that the learning processing has been completed (YES in step S47), the processing of the flowcharts is ended. In contrast, if the third learning unit 13 determines that the learning processing continues (NO in step S47), the processing proceeds to step S48. The determination of completion of the learning processing in step S47 may be made by the first learning unit 12 before the start of the first learning processing.

In step S48, the third learning unit 13 updates the parameter of the third partial model based on the error information calculated in step S47. The parameter described herein represents, for example, a weight or a bias. The third learning unit 13 transmits the error information from the intermediate layer close to the output layer to the intermediate layer closed to the input layer through backpropagation. After the third learning unit 13 transmits the error information from the intermediate layer that is included in the third partial model and is close to the input layer, to the second learning unit 31, the processing proceeds to subsequent step S49.

In step S49, the second learning unit 31 updates the parameter of the second partial model based on the error information transmitted from the third learning unit 13. The second learning unit 31 transmits the error information from the intermediate layer that is close to the output layer to the intermediate layer close to the input layer through backpropagation. After the second learning unit 31 transmits output from the intermediate layer close to the input layer to the first learning unit 12, the processing proceeds to step S50.

In step S50, the first learning unit 12 updates the parameter of the first partial model based on the error information transmitted from the second learning unit 31. After the first learning unit 12 updates the parameter for the first partial model, the processing proceeds to step S44. As described in step S47, the first learning unit 12 may determine completion of the learning processing at this timing.

Specifically, the information processing system 1 according to the present disclosure includes the first information processing apparatus 2 that is managed by the provider of the inference model, and the second information processing apparatus 3 that is capable of communicating with the first information processing apparatus 2 via the network 4 and that is managed by the user of the inference model, and performs the learning processing for performing learning on the inference model based on the neural network including the input layer, the intermediate layers, and the output layer. The first information processing apparatus 2 includes the training data acquisition unit 11, the first learning unit 12, and the third learning unit 13. The training data acquisition unit 11 acquires the training data including the learning data and the correct label. The first learning unit 12 performs the first learning processing by inputting the learning data to, of the inference model, the first partial model including the input layer and a part of the plurality of intermediate layers. The third learning unit 13 performs the third learning processing on the third partial model including the output layer using an output obtained through the second learning processing performed by the second information processing apparatus 3 and the correct label. The second information processing apparatus 3 further includes the second learning unit 31 that performs the second learning processing by inputting an output obtained through the first learning processing to a second partial model including an intermediate layer that is included in the inference model and is different from the intermediate layer in the first partial model.

In such a configuration, information about the first partial model and information about the third partial model are arranged in the first information processing apparatus 2 on the inference model provider side, and the first partial model and the third partial model serve as the network for confidentiality, so that the user of the inference model is enabled to perform learning on the inference model while unauthorized use of the model is prevented.

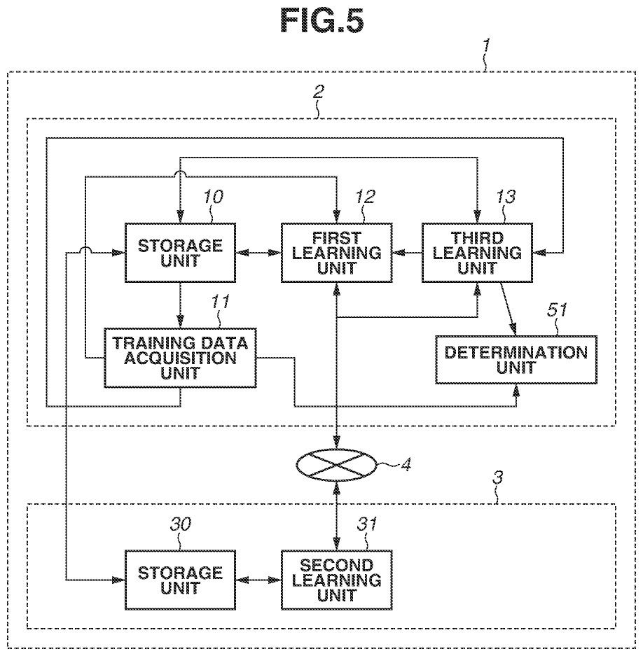

A second exemplary embodiment of the present disclosure will be described below. In the above-described exemplary embodiment, the description has been provided of the configuration in which the learning processing is performed on the trained inference model or the inference model that has not been subjected to the learning processing. In the present exemplary embodiment, the first information processing apparatus 2 further includes a determination unit 51 as illustrated in FIG. 5. The determination unit 51 determines whether learning is performed in an adequate range by the first learning unit 12 and/or the third learning unit 13.

A method with which the determination unit 51 makes determination will be described below using additional learning as an example. To determine whether the learning is performed in the adequate range, the determination unit 51 determines, for example, whether a component ratio of the correct label included in the training data satisfies a predetermined criterion. In such a case, the determination unit 51 compares information about the correct label that is to be classified by the inference model based on the neural network that performs the learning processing and the correct label for execution of the learning processing, and determines a possibility of the occurrence of biased learning, such as overlearning and sparse learning.

Alternatively, the determination unit 51 preliminarily holds data for verifying accuracy and compares accuracy of inference made by the inference model before the additional learning and accuracy of inference made by the inference model after the additional learning to determine a difference in accuracy falls within a predetermined range. As another example, the determination unit 51 may compare a parameter of the model before the additional learning and a parameter during the additional learning or after the additional learning, determine whether a variation in the parameters falls within a predetermined range, and thus determine whether the learning is performed in the adequate range. More specifically, the determination unit 51 determines whether the learning is performed in the adequate range for at least either the training data or the partial model. Here, the determination unit 51 may determine whether the learning is performed in the adequate range using another publicly known method.

### First Modification

In the above-described first and second exemplary embodiments, the description has been provided of the example in which the first learning unit 12, the second learning unit 31, and the third learning unit 13 each perform the learning processing to update all parameters of partial models included in the information processing system 1. In a first modification, the second learning unit 31 in the second information processing apparatus 3 performs additional learning on the second partial model included in the second learning unit 31, and the first learning unit 12 and the third learning unit 13 in the first information processing apparatus 2 each perform learning processing with fixed parameters. In execution of the additional learning, the layers included in the partial model of each of the first learning unit 12 and the third learning unit 13 transmit error information to a layer closer to the input layer to perform learning processing.

In the learning processing, configuring the information processing system 1 in such a manner enables reduction of the costs of managing models in the first information processing apparatus 2 serving as the information processing apparatus on the model provider side. For example, assume a case where the additional learning is performed by using the second information processing apparatuses 3 each managed by a plurality of users. In a case where a parameter of the model is updated in the first learning unit 12 and/or the third learning unit 13, the first information processing apparatus 2 is to manage at least partial models corresponding to the number of users. In contrast, updating a parameter of only the second partial model in the second learning unit 31 arranged in the second information processing apparatus 3 serving as the information processing apparatus managed by the user enables the provider of the model to reduce the number of models managed in the information processing apparatus of the provider of the model, thus reducing the costs of managing the models.

### Second Modification

In the above-described learning processing, the description has been provided of the case in which the learning processing is performed on the inference model using the backpropagation.

In a second modification, a description will be provided of a case in which learning processing is performed with a learning method other than the backpropagation, in the learning processing of the inference model.

For example, such a method may be a method of performing learning on a model that estimates a gradient that is supposed to be obtained for each layer, such as a synthetic gradient method, a method in which a fixed random matrix is used at the time of backpropagating an error, such as a feedback alignment method, a method of propagating a target instead of the error, such as a target propagation method, or any other method.

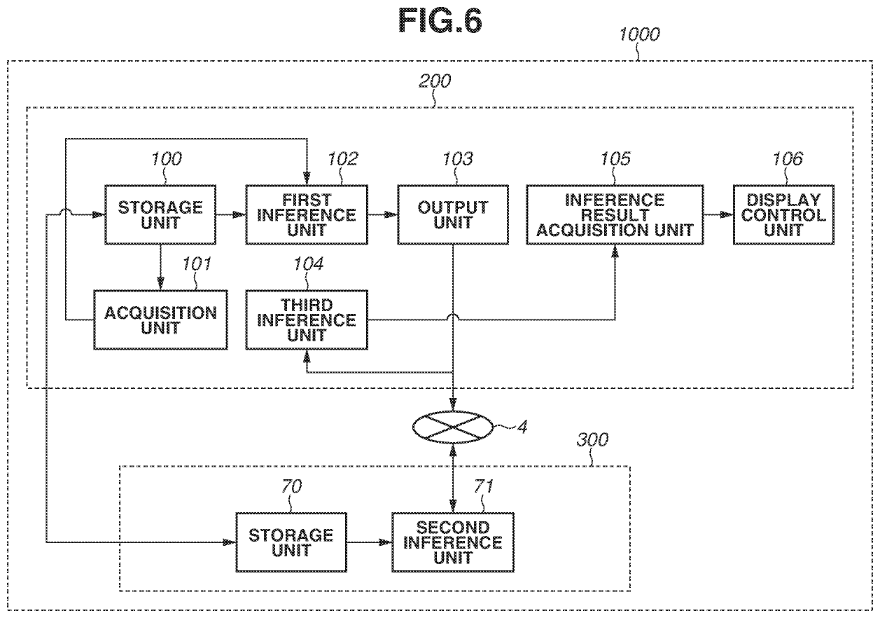

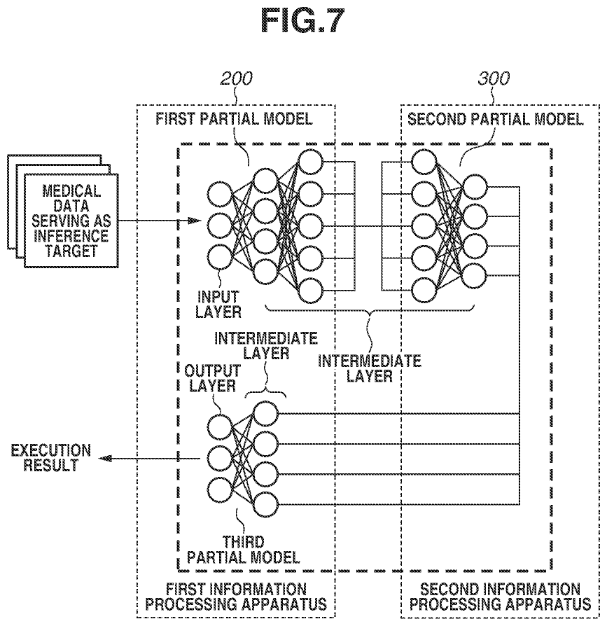

A third exemplary embodiment of the present disclosure will be described below. In the present exemplary embodiment, a description will be provided of an information processing system that makes inference using the neural network trained with the method according to the first or second exemplary embodiment, with reference to FIGS. 6 and 7. The neural network to be used for the inference may be implemented using a trained inference model that has been trained in another apparatus or the like instead of the above-described methods, or may be a neural network that is generated by execution of the additional learning through the learning processing in the above-described exemplary embodiments on the trained inference model that has been trained in another apparatus. A target of the inference using the neural network may be, for example, image data or the like captured by a security camera or the like in addition to medical data.

In the present exemplary embodiment, an information processing system 1000 includes a first information processing apparatus 200 on a model provider side, a second information processing apparatus 300 on the model user side, and the network 4 that connects the first information processing apparatus 200 and the second information processing apparatus 300 to be communicable with each other.

The first information processing apparatus 200 and the second information processing apparatus 300 each include a partial model which is a part of an inference model that performs inference processing on data serving as an inference target using first to third partial models and outputs an execution result. A combination of the partial models serves as the inference model based on one neural network. The inference model described herein is a trained model based on a neural network including an input layer, intermediate layers, and an output layer. A parameter for outputting an inference result is determined through learning processing, and a model having a pair of the parameter and a network model is defined as the inference model.

The first information processing apparatus 200 includes an acquisition unit 101, a first inference unit 102, an output unit 103, and a third inference unit 104. The acquisition unit 101 acquires data serving as the inference target. The first inference unit 102 performs first inference processing, in the inference processing, on the data serving as the inference target, using the first partial model including an input layer and at least a part of a plurality of intermediate layers which are included in the trained inference model. The trained inference model performs the inference processing on the data serving as the inference target and is based on the neural network including the input layer, the intermediate layers configured with the plurality of layers, and the output layer. The output unit 103 outputs a first inference result of the first inference processing to the second information processing apparatus 300, which is another information processing apparatus including the second partial model including layers that are different from layers included in the first partial model, in the inference model. The third inference unit 104 makes inference on an output from the second partial model in the second information processing apparatus 300, using the third partial model including the output layer. The first information processing apparatus 200 further includes an inference result acquisition unit 105 that acquires the inference result and a display control unit 106 that performs display control on a display unit.

Each constituent element of the first information processing apparatus 200 will be described below.

### (Storage Unit 100)

A storage unit 100 stores the first partial model including the input layer of the trained inference model, the third partial model including the output layer, and the data serving as the inference target. The data serving as the inference target is transmitted from the second information processing apparatus 300 on the inference model user side. The storage unit 100 stores, as the first partial model and the third partial model, a network corresponding to the respective partial models and a parameter that is obtained after training and that corresponds to the network, in association with each other. The data serving as the inference target may be medical data automatically transferred from a modality or an external image server. A part of the trained inference model indicates a continuous portion from a certain layer to another layer, but is not limited thereto, and may be a continuous portion from a certain neuron to another neuron or an isolated neuron. The partial model may be a plurality of portions that is not adjacent to each other included in the trained inference model.

### (Acquisition Unit 101)

The acquisition unit 101 acquires the data serving as the inference target from the storage unit 100, and transmits the acquired data serving as the inference target to the first inference unit 102.

### (First Inference Unit 102)

The first inference unit 102 acquires the first partial model from the storage unit 100, and makes first inference on the data as the inference target using the first partial model. The first inference unit 102 transmits a result of the first inference made by the first partial model to the output unit 103. In the present exemplary embodiment, the first partial model includes, of the trained inference model, the input layer and at least a part of the plurality of intermediate layers, and transmits output from the intermediate layers to the output unit 103. The output from the intermediate layer described herein is information about a tensor. In a case where the inference model is a model based on a convolutional neural network (CNN), the output is a feature map.

### (Output Unit 103)

The output unit 103 transmits the result of the first inference to the second information processing apparatus 300 serving as another information processing apparatus. In a case where there is a plurality of inference models, the partial model that has been used for the first inference outputs information about a corresponding inference model to the second information processing apparatus 300.

### (Third Inference Unit 104)

The third inference unit 104 acquires the third partial model from the storage unit 100, acquires an output from the second partial model in a second inference unit 71 in the second information processing apparatus 300, and makes third inference using the third partial model. In the third inference unit 104, the third partial model is a partial model including the intermediate layers and the output layer, and uses the output layer to output the inference result.

### (Inference Result Acquisition Unit 105)

The inference result acquisition unit 105 acquires the inference result of the third inference processing performed on the medical image data serving as the inference target from the third inference unit 104. In response to acquiring the inference result, the inference result acquisition unit 105 transmits the inference result to the display control unit 106.

### (Display Control Unit 106)

The display control unit 106 performs control of displaying the inference result acquired by the inference result acquisition unit 105 on the display device. The display device is, for example, an information processing apparatus such as a display attached to the second information processing apparatus 300 and a mobile terminal of a hospital official by way of an external server.

The first information processing apparatus 200 may be configured of a single hardware device, or may be configured of a plurality of hardware devices. For example, by utilizing cloud computing or distributed computing, a plurality of computers may collaborate to implement functions and processing of the first information processing apparatus 200.

Meanwhile, the second information processing apparatus 300 on the user side includes the second inference unit 71. In the inference processing on the data as the inference target, with use of, as input, a result of the first inference processing using the first partial model including, of the trained inference model that performs the inference processing on the data serving as the inference target and that is based on the neural network including the input layer, the intermediate layers, and the output layer, the input layer and at least a part of the plurality of intermediate layers, the second inference unit 71 uses the second partial model including layers that are different from those included in the first partial model to perform second inference processing, in the inference processing. The second information processing apparatus 300 further includes a storage unit 70 that stores the second partial model.

In the present exemplary embodiment, the second partial model in the second inference unit 71 includes, of the trained inference model, intermediate layers that are different from the intermediate layers included in the first inference model. The network configuration of the above-described partial models is merely an example, and the number of partial models and the number of information processing apparatuses is changeable in various manners.

### (Storage Unit 70)

The storage unit 70 stores a network corresponding to the second partial model and a trained parameter corresponding to the network in association with each other. The partial model represents a continuous portion from a layer to another layer, but is not limited thereto, and may be a continuous portion from a neuron to another neuron or an isolated neuron. The partial model may be a plurality of portions that is not adjacent to each other included in the inference model.

### (Second Inference Unit 71)

The second inference unit 71 acquires the second partial model from the storage unit 70, and makes second inference on the data serving as the inference target using the second partial model. The second inference unit 71 then transmits an inference result of the second inference to the first information processing apparatus 2. Here, in a case where information about selection of the trained inference model is acquired from the first information processing apparatus 200, the second inference unit 71 acquires the second partial model corresponding to the trained inference model and makes the second inference. Since the second partial model is configured only with intermediate layers, the second inference unit 71 transmits output from the intermediate layers to the first information processing apparatus 200.

The above-described configuration of the second information processing apparatus 3 enables retention of parameter information even in a case where a second partial model is created for the respective information processing apparatuses for a plurality of users through the additional learning or the like according to the first exemplary embodiment, the second exemplary embodiment, for example. Even in a case where the plurality of second partial models is created through the additional learning, the number of partial models corresponding to the respective second partial model may be one, thus facilitating the management to be performed by the provider of the model.

The arrangement of the first partial model including the input layer and the third partial model including the output layer on the first information processing apparatus 200on the model provider side enables detection and prevention of an unauthorized operation such as adversarial example. This will be described below with reference to a fourth exemplary embodiment.

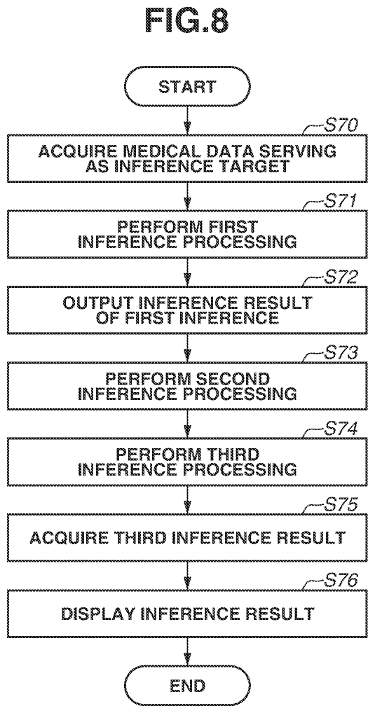

The processing of the inference of the information processing system 1000 according to the present exemplary embodiment will be described below with reference to FIG. 8.

In step S70, the acquisition unit 101 in the first information processing apparatus 200 acquires the data serving as the inference target. In response to acquiring the data serving as the inference target, the acquisition unit 101 transmits the acquired data serving as the inference target to the first inference unit 102, and the processing proceeds to step S71. The acquisition unit 101 may acquire the data serving as the inference target from the second information processing apparatus 300, which is the information processing apparatus on the user side, and the data serving as the inference target may be stored in the storage unit 100.

In step S71, the first inference unit 102 in the first information processing apparatus 200 uses the first partial model including the input layer and at least a part of the plurality of intermediate layers to execute the first inference processing on the data serving as the inference target. After execution of the first inference processing, the first inference unit 102 transmits an inference result of the first inference processing to the output unit 103, and the processing proceeds to step S72.

In step S72, the output unit 103 in the first information processing apparatus 200 outputs an inference result of the first inference to the second information processing apparatus 300, and the processing proceeds to step S73.

In step S73, the second information processing apparatus 300 uses the second partial model to make the second inference with the inference result from the first inference unit 102 serving as input. The second partial model includes a network including, of the trained inference model, the intermediate layers between the intermediate layers of the first partial model and the intermediate layers of the third partial model. The second inference unit 71 transmits an output from the intermediate layers of the second partial model as a result of the second inference to the first information processing apparatus 200, and the processing proceeds to step S74.

In step S74, the third inference unit 104 in the first information processing apparatus 200 uses the third partial model to make third inference with the result of the second inference serving as input. The third inference unit 104 transmits a result of the third inference to the inference result acquisition unit 105, and the processing proceeds to step S75.

In step S75, the inference result acquisition unit 105 acquires the result of the third inference as a result of inference for the data serving as the inference target, and transmits the acquired inference result to the display control unit 106.

In step S76, the display control unit 106 performs control of displaying the inference result acquired by the inference result acquisition unit 105 on the display device. The display device is, for example, an information processing apparatus, such as a display attached to the second information processing apparatus 300 and a mobile terminal of a hospital official, by way of an external server.

The present exemplary embodiment enables execution of the inference processing on the data of the inference target while guaranteeing confidentiality of the inference model.

A fourth exemplary embodiment of the present disclosure will be described. In the present exemplary embodiment, the first information processing apparatus 200 further includes a determination unit 501 that determines whether inference is made in an appropriate range.

The determination unit 501 acquires the data serving as the inference target and the inference result, and determines whether unauthorized inference is made. For example, the determination unit 501 determines whether the inference does not correspond to an adversarial example. The adversarial example is data in which perturbation is added to input data, and is, for example, generated for the purpose of changing an inference result based on machine learning by addition of data in which a pattern of perturbation is changed to image data. In a case where such continuous data as correspond to the adversarial example is input as the data as the inference target among data as a plurality of inference targets, the determination unit 501 determines that the inference is unauthorized inference. This configuration can guarantee reliability in addition to confidentiality of the inference model.

### Other Exemplary Embodiments

The present disclosure is implemented by execution of the following processing. That is, the processing is implemented by installing software (program) that implements one or more functions of the exemplary embodiments described above in a system or an apparatus through a network or a storage medium of various kinds, and a system or a computer (or a CPU or a microprocessing unit (MPU)) of the apparatus loading and executing the program.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-188733, filed Nov. 19, 2021, which is hereby incorporated by reference herein in its entirety.

What is claimed is:

1. An information processing system, comprising a first information processing apparatus and a second information processing apparatus configured to communicate with the first information processing apparatus via a network, the information processing system being configured to perform learning processing on an inference model based on a neural network including an input layer, a plurality of intermediate layers, and an output layer,
the first information processing apparatus comprising:
a training data acquisition unit configured to acquire training data including learning data and a correct label;
a first learning unit configured to perform first learning processing by inputting the learning data to a first partial model including the input layer and a part of the plurality of intermediate layers of the inference model; and
a third learning unit configured to perform third learning processing on a third partial model including the output layer using an output obtained through second learning processing performed by the second information processing apparatus and the correct label,
the second information processing apparatus comprising a second learning unit configured to perform the second learning processing by inputting an output obtained through the first learning processing to a second partial model including an intermediate layer that is included in the inference model and is different from the part of the plurality of intermediate layers included in the first partial model.

2. The information processing system according to claim 1,
wherein the first partial model and the third partial model serve as a network for confidentiality, and
wherein the second partial model serves as a network for publication.

3. The information processing system according to claim 1, wherein the training data acquisition unit is configured to acquire the training data from the second information processing apparatus.

4. The information processing system according to claim 1, wherein the third learning unit is configured to acquire the correct label from the training data acquisition unit and acquire error information based on the correct label and an output from the output layer.

5. The information processing system according to claim 4, wherein the third learning unit is configured to update a parameter of the third partial model based on the error information and backpropagation.

6. The information processing system according to claim 5,
wherein the second learning unit is configured to update a parameter of the second partial model based on the error information transmitted from the third learning unit, and
wherein the first learning unit is configured to update a parameter of the first partial model based on the error information transmitted from the second learning unit.

7. The information processing system according to claim 1, wherein the second learning unit in the second information processing apparatus is configured to generate the second partial model by performing additional learning with parameters of the first partial model and the third partial model being fixed.

8. The information processing system according to claim 1, further comprising a determination unit configured to determine whether the first information processing apparatus performs learning, in an adequate range, for at least either the training data or a partial model.

9. The information processing system according to claim 8, wherein the determination unit is configured to determine whether the first information processing apparatus performs the learning, in the adequate range, for at least either the training data or a partial model, depending on whether a component ratio of the correct label included in the training data satisfies a predetermined criterion.

10. The information processing system according to claim 8, the determination unit is configured to determine whether the first information processing apparatus performs the learning, in the adequate range, for at least either the training data or a partial model, depending on whether a variation in parameter of the partial model due to the learning satisfies a predetermined criterion.

11. An information processing system configured to make inference using the inference model based on the neural network that has been trained through the learning processing according to claim 1,
wherein the first information processing apparatus further includes an acquisition unit configured to acquire data serving as an inference target, and
wherein the information processing system makes the inference on the data serving as the inference target using the first partial model, the second partial model, and the third partial model.

12. The information processing system according to claim 11, wherein the first information processing apparatus further includes a determination unit configured to determine whether the inference is made, in an adequate range, for at least one of the data as the inference target or an inference result.

13. The information processing system according to claim 1, wherein the first information processing apparatus is managed by a provider of the inference model, and the second information processing apparatus is managed by a user of the inference model.

14. An information processing method for perform learning processing on an inference model based on a neural network including an input layer, a plurality of intermediate layers, and an output layer using a first information processing apparatus and a second information processing apparatus configured to communicate with the first information processing apparatus via a network, the information processing method comprising:
causing the first information processing apparatus to
acquire training data including learning data and a correct label,
perform first learning processing by inputting the learning data to a first partial model including the input layer and a part of the plurality of intermediate layers of the inference model, and
perform third learning processing on a third partial model including the output layer using an output obtained through second learning processing performed by the second information processing apparatus and the correct label; and
causing the second information processing apparatus to perform the second learning processing by inputting an output obtained through the first learning processing to a second partial model including an intermediate layer that is included in the inference model and is different from the part of the plurality of intermediate layers in the first partial model.
